(19) United States
(12) Patent Application Publication
(10) Pub. No.: US 2003/0152182 A1
(43) Pub. Date: Aug. 14, 2003

(54) Optical exchange method, apparatus and system for facilitating data transport between WAN, SAN and LAN and for enabling enterprise computing into networks

(76) Inventors: B. Anand Pai, Cupertino, CA (US); Srinivasan Krishnaswami, Fremont, CA (US); Terence Chui, Milpitas, CA (US)

Correspondence Address: OPPENHEIMER WOLFF & DONNELLY, P. O. BOX 10356, PALO ALTO, CA, 94303, US

(21) Appl. No.: 09/935,800

(22) Filed: Aug. 22, 2001

Related U.S. Application Data
(60) Provisional application No. 60/226,853, filed on Aug. 22, 2000.

(51) Int. Cl. H04L 7/00

(52) U.S. Cl. 375/372

(57) ABSTRACT

An integrated circuit device for use in forming a communication interface for an enterprise server including a system controller, at least one CPU, a system bus communicatively interconnecting the controller and the CPU, a system memory, a first optical interface for facilitating data transport between the device and SONET based networks, and a second optical interface for facilitating data transport between the device and ethernet/Fibre Channel based networks. The integrated circuit device is comprised of an interface including a SONET-in engine for receiving SONET input data from the first optical interface and for extracting synchronous payload envelopes (SPE) therefrom, a deframer for extracting data packets from the incoming SPE, a plurality of ethernet/Fibre Channel (E/FC) ports selectively programmable to function as either a GbE port or an FC port for communicating with the second optical interface, a generic interface unit (GIU) for communicating data signals to and from the system bus, and a packet engine (PE) responsive to routing tables and operative to sort and forward each extracted data packet IP packet or FC frame via the BIC to a particular one of the plurality of GbE/FC ports.

### BACKGROUND OF THE INVENTION

1. Field of the Invention

Briefly, the present invention relates to an improved method, apparatus and system for communicating high volumes of data over various types of networks, and more particularly, to an improved circuit, chip and system architecture addressing current SAN-LAN-WAN integration bottlenecks by means of a revolutionary and novel approach to the integration and management of SAN-LAN-WAN-compute environments.

2. Description of the Prior Art

Today, more and more Internet-related applications are driving the demands for broadband bandwidth communications networks. Companies which are heavily dependent on networking as their business service backbone are affected by this Internet evolution. Network managers are struggling to supply high performance communications backbone to support Storage and Server Area Network (SAN), LAN-based Enterprise systems, and Internet-related data intensive traffic across Wide Area Networks (WAN). Today's network infrastructure cannot easily meet these enormous demands for bandwidth and the flexibility to support multiple protocol services that usually exist in the Enterprise environment.

Many of the network technology companies have moved from their infancy to maturity in the past ten years and the trend for WAN is moving away from TDM (Time-Division Multiplexing) technology to packet-based infrastructures. Organizations are improving their communications backbone from megabit rate to gigabit rate and some are even moving to terabit rate.

In FIG. 1 a diagram is provided to illustrate prior art topologies for enabling the SAN-LAN-WAN and Enterprise environments to communicate with other similar environments. As can be seen in the drawing the (Storage Area Network) SAN elements 10 and (local Area Network) LAN elements 12 merge with the Enterprise elements and 14 (the Server), the Server in turn interfaces with a myriad communications equipment loosely depicted as a “Network Cloud” 16 which interfaces with a Network Element (NE) 18 and that aggregates data from the lower level elements and connects to a remote Network Element 20 thereby forming the (Wide Area Network) WAN 19. The remote NE 20 likewise communicates via a Network Cloud 22 to a Server 24 coupled to a remote SAN 26 and LAN 28. As depicted, the elements that form the Network Cloud 16 (and 22) include a switch or hub element 30, a router 34 and a SONET Add-Drop Multiplexer (ADM) 36. The LAN and SAN feeds from the Server 14 are connected to a switch element 30 which aggregates feeds from other Servers as suggested by the lines 32 and connects the combined data to the router 34. Router 34 connects this feed as well as feeds from other routers, as suggested at 35, to ADM 36 which connects to the WAN. The layers of hierarchy involved should be clear from this figure.

In FIG. 2, a simplified block diagram is presented to illustrate the principal functional components of a typical Server. As depicted, the Server includes a plurality of Central Processing Unit (CPU) cards 38 connected via a System Bus 40 to a System Controller 42. Controller 42 is coupled to Memory 44 and to an Input-Output (I/O) system 46 that under control of the Controller 42 facilitates the communication of data between LAN and SAN interfaces and an Interface to Asynchronous Transfer Mode (ATM) Switches or SONET backbone. As is apparent from the figure, the LAN and SAN Interfaces extend from the I/O system of the Server and no direct interfaces to the WANs exist. Lower bit rate feeds from the Servers are aggregated in external switches or hubs which then connect routers and add-drop multiplexers before connecting to the WAN. In this environment the SANs, the Enterprise Servers and the WAN are all individually managed, and the dollar cost to the consumer is enormous.

### SUMMARY OF THE INVENTION

It is therefore a principal objective of the present invention to provide means for combining the functions implemented by the switch/hub element, router, and SONET ADM into a single unit that cooperates with a standard Server to provide direct connection between LANs, SANs and WANs.

Another objective of the present invention is to provide a low cost, reliable, and high performance system which can be easily configured to support multiple networking services.

The present invention provides a multi-services networking method, apparatus and system having high reliability with built in redundancy, and one which also provides superior performance at a reasonable cost. It takes advantage of the maturity of the SONET (Synchronous Optical Network) standard and utilizes the SONET framing structure as its underlying physical transport. It supports major protocols and interfaces including Ethernet/IP, Fibre Channel, and ATM. These protocols usually represent 95% of the LAN/WAN traffic in the Enterprises. Based on ASIC-implemented and software-assisted packet-forwarding logic, the present invention boosts the packet switching functions to match the multi-gigabit data transfer rate and will allow corporations to enhance their Enterprise Network (to 2.4 Gbps and beyond) without sacrificing their existing investments.

Since SONET has been the standard for transporting broadband traffic across the WAN in the telecommunications industry for many years, and this optical networking technology is moving into the data communication and the large Enterprises of the world, the present invention can utilize this solid, and reliable technology as its transport backbone. ATM and IP protocol, both of which have been the dominant networking technologies that have provided network connectivity for organizations during the last decade, as well as Fibre Channel, which focuses on addressing the data-intensive application in the Enterprise, are supported.

The present invention is capable of transferring close to wire-speed bandwidth between multiple network domains within an Enterprise. This capability is mainly attributed to the use of the SONET backbone and the adaptive data forwarding technique used in accordance with this invention.

The subject system uses SONET for multiple protocol payloads. The supported protocols include the following (see FIG. 3 also):

SONET—provides highly reliable high speed transport of multi-protocol payloads at the rate of 51.84 Mbps. 155.52 Mbps, 622.08 Mbps, 2488.32 Mbps, 9953.28 Mbps, and 39,813.12 Mbps. Currently, it is mainly used in the telecommunications industry for voice and data transport.

ATM—devised to carry high-bandwidth traffic for applications such as video conferencing, imaging, and voice. However, with the explosion of the Internet, ATM has taken on the duty of transporting legacy protocols between the Enterprises and the Service Providers, and traffic within the Service Providers network. It carries traffic mainly at the rate of 51.84 Mbps, 155.52 Mbps, 622 Mbps (and is moving to support OC-48 transfer rate).

Fibre Channel—provides data transport for both “channel” devices (e.g. SCSI) and “network” devices (e.g. network interfaces). It is an evolving standard which addresses the Server and Storage Area Network (SAN). Fibre Channel operates at the speed of 133 Mbps, 266 Mbps, 530 Mbps, and 1062 Mbps depending on the media.

Ethernet—Ethernet/IEEE 802.3 provides high-speed LAN technology to the desktop users for many years. Based on the physical-layer specifications, it offers data rates of 10 Mbps (e.g. 10BaseT) and 100 Mbps (e.g. 100BaseT). Gigabit Ethernet is an extension of the IEEE 802.3 Ethernet standard. In order to accelerate to 1 Gbps, Gigabit Ethernet merges two standard technologies: IEEE 802.3 Ethernet and ANSI X3T11 Fibre Channel. Ten Gigabits Ethernet is also being standardized.

IP—most common protocol exists and used today. With the even-increasing Internet traffic, IP is the prominent networking protocol from desktop to Enterprise Server. IP can ride on top of any protocol and physical media. The current support for IP is at the rate from a narrowband rate of 9.6 kbps to a broadband rate of 1000 Mbps.

### IN THE DRAWINGS

FIG. 1 is a diagram schematically illustrating a prior art WAN/SAN/LAN system;

FIG. 2 is a diagram schematically illustrating a prior art server;

FIG. 3 is a diagram schematically illustrating protocols supported over SONET;

FIG. 4 is a diagram schematically illustrating a WAN/SAN/LAN system implemented using apparatus in accordance with the present invention;

FIG. 5 is a diagram schematically illustrating a server incorporating OPX cards in accordance with the present invention;

FIG. 6 is a block diagram illustrating the architecture of an OPX card cards in accordance with the present invention;

FIG. 7 is a block diagram illustrating the architecture of an OCU chip cards in accordance with the present invention;

FIG. 8a is a diagram illustrating the OPX labeling in accordance with the present invention;

FIG. 8b is a diagram illustrating a Forwarding Information Base Table in accordance with the present invention;

FIG. 8c is a simplified flow chart illustrating the data transfer process in sending data from the WAN to either the SAN or the LAN environment in accordance with the present invention;

FIG. 9 illustrates in perspective a pair of OPX Cards as mounted to the Mother Board of a Server in accordance with the present invention;

FIG. 10 is a diagram illustrating the scalability of the OPX architecture; and

FIGS. 11-14 are diagrams generally illustrating application of the present invention in various network topologies.

### DETAILED DESCRIPTION OF THE PREFERRED EMBODIMENTS

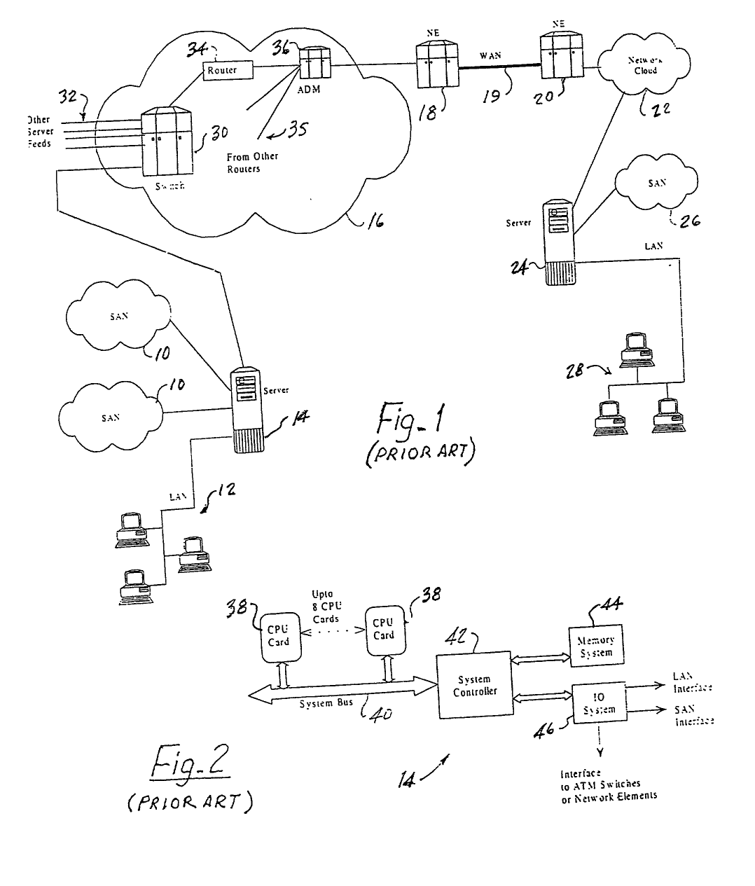

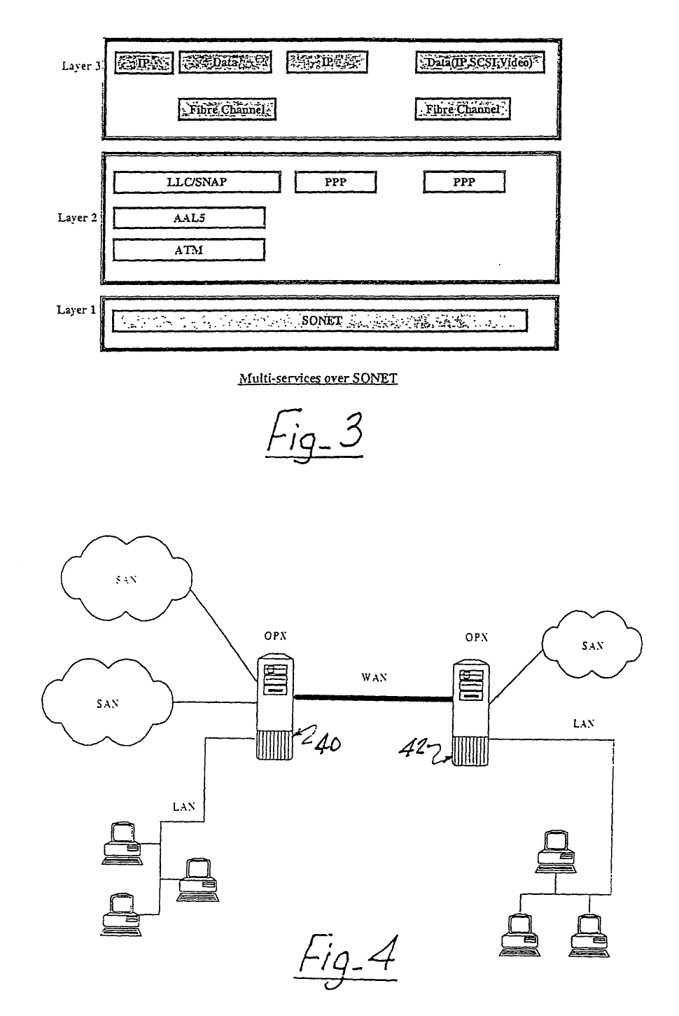

Turning now to FIG. 4 which shows Optical Exchange (OPX) topology in accordance with the present invention in its most general form, note that the Network Components 16 and 22 depicted in the prior art system of FIG. 1 are eliminated, and the SAN-LAN-WAN and Enterprise environments are, again in accordance with the present invention, integrated into OPX servers 40 and 42 depicted at opposite ends of the WAN. In place of the multiple feeds connecting at the switches 30 and SONET ADMs 36 shown in FIG. 1, the topology of the present invention allows multiple OPX servers to connect to the SONET backbone, thereby eliminating the need for complex network switches and routers. Further, since the OPX server is scalable, suitably configured systems can even replace the aggregation function of the ADM. The OPX topology provides unprecedented levels of price performance, managed bandwidth delivery from/into the WAN-LAN edge, end-user scalability of performance WAN to LAN, seamless traffic flow to/from SAN-LAN-WAN, total network management from single administration station, and integration with legacy equipment.

The architecture of the present invention has been developed through a merger of silicon, systems and network management designs. The basic building block of the architecture is a new silicon chip device, which will hereinafter be referred to as the “OPX Chip Unit” or “OCU”. In accordance with the invention, one, two, or more OCUs and associated electronics including hardware, software and firmware are mounted on a PC card and function to deliver high bandwidth with central management.

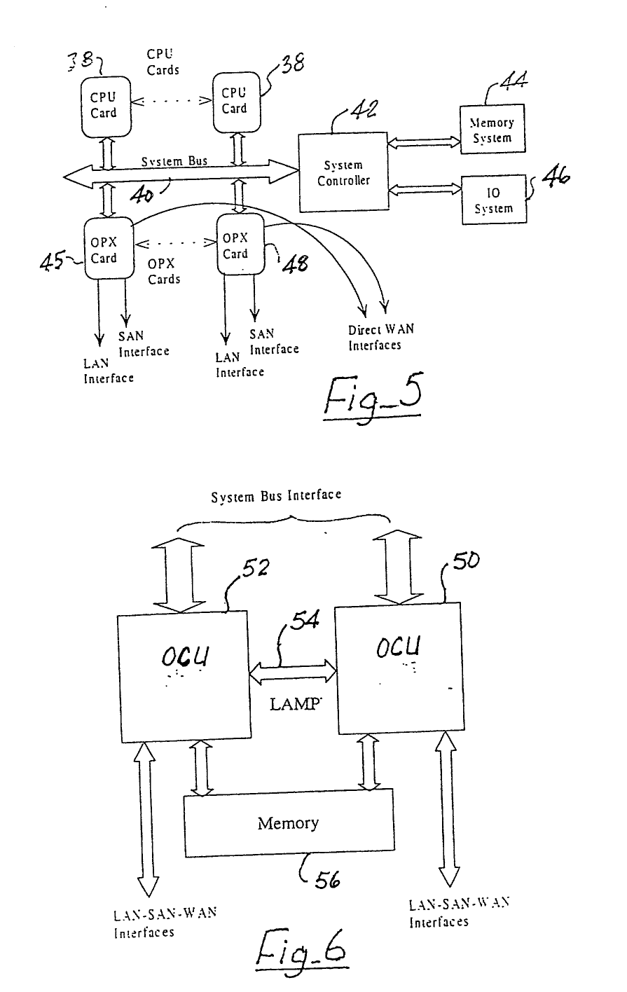

In FIG. 5 of the drawing, the basic architecture of an OPX Server is shown. As in the prior art device, this Server also includes a plurality of CPU cards 38, a system bus 40, a system controller 42, a memory system 44 and an I/O system 46. However, in addition, it includes one or more OPX Cards 48 plugged into the system bus 40. Each OPX Card provides a means for coupling LAN and SAN interfaces directly to a WAN Interface. The OPX Server in effect moves the LAN and SAN from the I/O domain, and through the OPX Cards connects them directly to the WAN. This model is applicable for any Server and is totally scalable with the number of CPU cards used.

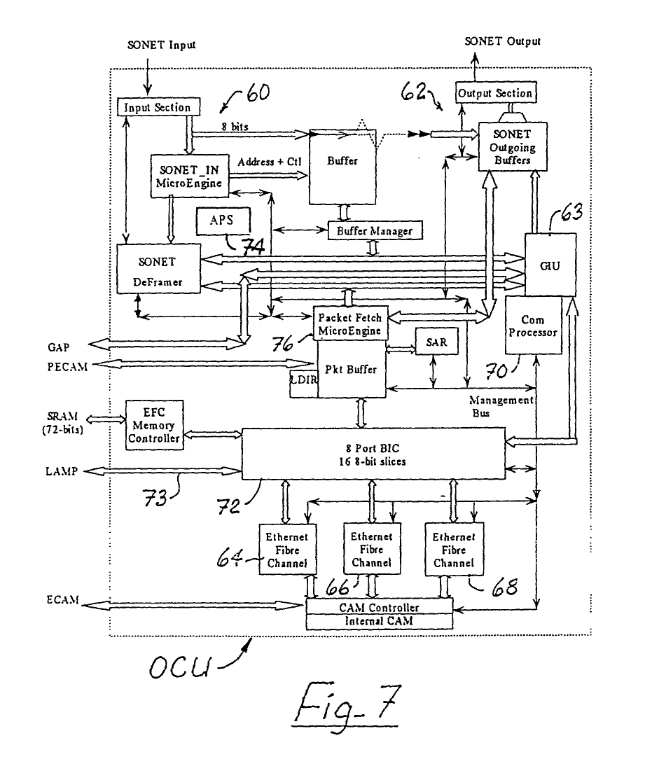

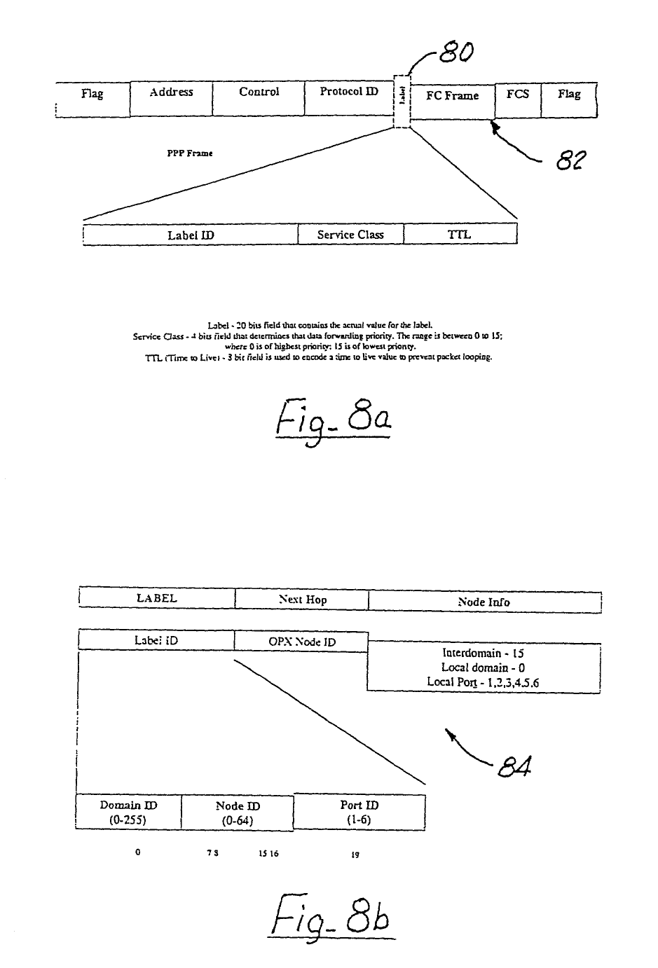

FIG. 6 is a high-level block diagram illustrating the principal functional components of an OPX Card. Two OCUs 50 and 52 are normally included in an OPX Card. However, this is scalable, and versions with four OCUs on an OPX Card are also possible. The OCUs communicate with the server system using an Interface to the System Bus 40 as shown in FIG. 5. Communication between the OCUs is through a proprietary bus 54, known as the (LightSand Architecture Message Protocol) LAMP Bus, which is capable of operating at 12.8 Gbps (gigabits per second) transfer rates. Critical chip-to-chip information such as Automatic Protection Switching (“APS”) is passed between the OCUs using the LAMP Bus. The LAMP Bus also facilitates node-to-node connectivity across both OCUs, that is, a LAN node on the first OCU 50 can communicate with (or connect to) the SAN node on the second OCU 52 using the LAMP Bus, and vice versa.

The OPX cards also include memory 56 in the form of memory chips (SRAMs and SDRAMs) that minimize the traffic needs on the System Bus. (Although presently configured as external memory, it is conceivable that, as technology improves, the memory could alternatively be imbedded in the OPU chip.) This enables the server's CPU cards to utilize all available bandwidth on the System Bus to provide data and execute applications as needed by the Enterprise computing environment. As can be seen, this model has effectively merged the LAN-SAN-WAN and Enterprise computing environments into a single server box thus providing a compute and communications platform that did not exist prior to this invention.

One aspect of the OPX's uniqueness arises from the fact that the OCUs interface with standard System Busses to work with each other. For example, Cards built with dual OCUs can reside in processor slots of servers such as Intel's Xeon-based servers and use the Front Side Bus (FSB) as a System Bus. The FSB will be used to accommodate Host Processor to OCU communication (for set-up); OCU to host processor communication (host intervention mechanism); OCU to host memory (Direct Memory Access); and OPX-to-OPX communication and data transfer.

FIG. 7 is a block diagram illustrating the basic functional components of the OCU devices. The SONET sections 60 and 62 identify the WAN interfaces. (A)The Ethernet/Fibre Channel blocks 64, 66, and 68 identify the LAN and SAN interfaces. In this architecture, the choice between Ethernet ports and Fibre Channel ports is configurable; that is, each port will function either as an Ethernet (gigabit Ethernet) or as a Fibre Channel port. Data switching between the Ethernet and Fibre Channel domains is also allowed. The GAP is a system bus interface and is associated with a Generic Interface Unit (GIU) 63. GAP is an acronym for General Architecture Protocol or Generic Access Port, meaning that this port will work with any System Bus on any Server. The Communications Processor block 70 performs the management functions that are needed by the OCU. The Bus Interconnect Controller (BIC) 72 connects all of the major blocks and also controls the LAMP Bus 73. The LAMP Bus 73 is a non-blocking interface that ports on the OCUs use to communicate with each other, with memory, and with the GAP. This provides total connectivity between ports, the CPU and memory. The LAMP interface is currently designed to operate at 100 MHz (128 bits), thereby providing a combined bandwidth of 12.8 Gbps. The APS 74 is an Automatic Protection Switching mechanism supported by the OPX architecture and allows WAN traffic to be redirected to a protection line or protection card on the same server. The Packet Engine 76 sorts incoming data packets and forwards, or “routs”, them to an output port.

Routing has traditionally been handled by software centric solutions such as the Cisco router implementation which reaches its limit when handling the data switching function at gigabyte rates. Transferring frames across a single network link within a LAN is usually the task for a Layer 2 switch. In order to provide end-to-end communication throughout the OPX networking domains and across the WAN to external Fibre Channel/IP domains, high-speed packet forwarding is required. Since routing protocols usually impose a heavy burden on the routing server, the routing speed can affect the overall performance of the network.

In accordance with the present invention, the OPX system performs high performance packet forwarding functions and allows for data link independent support. Based on ASIC-implemented and software-assisted packet-forwarding logic, the OPX system boosts the packet switching functions to enhance the Fibre Channel technology in the WAN internetworking area. It provides a low cost solution to bridge Storage Area Network islands into a high-speed Fibre Channel network without any compromise in performance and with minimal efforts.

The system supports both the IP Packet switching and Fibre Channel Frame switching. In implementing packet forwarding functions, the OPX deploys high performance Software-Assisted hardware switching functions performed by a data forwarding engine that enables high speed data transport (gigabyte). The high performance switching function results in part from use of the LightSand-defined OPX Labeling System (OLS) which is modeled after the IETF Multi-Protocol Label Switching (MPLS) method with a variant.

In addition to incorporating the Label Switching and Forwarding technique identified in the MPLS, it also takes advantage of knowledge of the OPX network to derive the best possible forwarding method including the physical layout of the SONET Ring or Linear system, the physical Trunk Node interface, and a hierarchically ordered set of IP address blocks.

Combined with software routing functions, the Data Forwarding engine of the OPU examines the destination addresses of the initial incoming packets, looks up the address in the routing table, re-writes the packet control data, and forwards the packet to the appropriate output channel for transport. The subsequent packets will be handled through Label switching at Layer 2; that is, the subsequent packets are treated as the same “Data Flow” as the initial packet. “Data Flow”, which is referred to as “Forwarding Equivalence Class (FEC)” in the MPLS, is defined as any group of packets that can be treated in an equivalent manner for purposes of forwarding. The OPX data flow is defined as groups of packets having the same destination addresses, or same Fibre Channel Domain ID.

More specifically, the function of the SONET-IN micro engine 61 is to manage the Add-Drop sequences. This implies the existence of configuration registers that will work with the provisioning software to dictate the add-drop slots for certain types of frames. In the case of ATM over SONET, the target VC I-VPI addresses may also be part of this configuration register set. The configuration registers will be set up when the system is installed at the customer site. A default set of values will be defined for these registers (power-on values). Programming of these registers will be through the PCI interface on the OPU.

In a TM (terminal multiplexer) mode where all of the frames are dropped, the SONET-IN micro engine will manage the data flow between the FIFO buffer 65 and the off-chip memories.

Once the framing pattern has been detected, the SONET-IN stage will initiate a byte count operation and either drop the bytes into the buffer 65 or forward them to the SONET-OUT stage 62. The overhead of bytes will be processed in the SONET-IN engine.

Once the correct byte lanes are identified, the SONET-IN engine will store the bytes in the buffer 65. Buffer addressing functions will be done in the SONET-IN engine 61. The SONET-IN engine will also keep track of the number of bytes in the buffer 65 and set up the memory controller 67 for DMA transfers of the payload from the buffer to external memory. Since the data flowing into the buffer could potentially be one complete STS-48 frame, the DMA must clear the buffer in the most expedient manner. Bytes that are not “dropped” flow seamlessly to the output queues where they are byte multiplexed with payloads from other OPX sources. The most critical function in the SONET-IN engine is the identification of the Data Channel Communications (DCC) bytes and the performance of any switching functions that may be needed during failures.

The SONET-IN buffer 65 is a 2-port device (one write, one read). Port 1 and is a byte write interface and port 2 is a 16 byte read interface. The write port must have a write cycle time of less than 3 nS. The read port must have a read access time of less than 8 nS.

The S A R (segmentation and reassembly processor) 69 is a high performance segmentation and reassembly processing process or. When the OPU is configured to support ATM over SONET, the payloads are in the form of ATM cells (5 byte header+48 byte payload). The SAR interfaces with the FSB through the LAMP ports. The segmentation and reassembly of packets can be done either in the host (server) memory or in the chip's external memory. The SAR performs all AAL5 functions including the segmentation and re-assembly. During reception, ATM cells received are reassembled into PDUs in the host memory. During transmit, the PDUs are segmented and processed by the AAL5 SAR into ATM cells. The SAR block performs CRC-10 generation and checking for OAM and AAL ¾ cells. Since the SAR is connected to both the packet engine and the LAMP system, it can work off PDUs in the internal cache and from external memory.

During the receive operation, the SONET-IN passes the frame to the de-framer block 71. The de-framer block extracts the packet from the SONET-IN payload. After the packet has been extracted, the de-framer sends the package to the packet engine 76 and looks at the packet and delivers it to the intended destination. The nature of the extraction depends on the type of packet. For example, for an ATM payload, the SAR will be used to extract the PDUs. For IP packets, the management software will process the packet and update the routing tables. The packet engine 76 plays the role of the central switching engine in the OPU. It also serves as the packet terminating equipment for packets that are dropped.

During the transmit operation, Ethernet or Fiber Channel ports will arbitrate with the BIC module for transfer of data, and will dump the data into the off-chip EFC memory. Once the EFC memory data is in the memory, BIC will update the command queue for the new/pending packet to be transported. The packet engine will then issue a request for the BIC, requesting access to the EFC data, which will be transmitted by the BIC using the LAMP protocol. The payload from EFC memory will be encapsulated within the PPP and HDLC frame and stored in the packet buffer. If the final destination of the packet is outside of the OPX domain (trunk node), packets will be segmented into ATM cells in the SAR and the resulting segmented and or encapsulated payload will be transported to the SONET-OUT micro engine in the output section 62. Data communication channel (DCC) packets will be fetched from the server main memory through the BIU ports and stored in a dedicated local buffer before being transported to the SONET-OUT micro engine. The transmission of DCC packets will be done before the actual payload from the packet engine is sent to the SONET-OUT micro engine.

The Generic Interface Unit (GIU) is, for example, the interface to the FSB on Intel platforms.

The communications processor 70 is a centralized collection agent for all of the performance data. Closely associated with the communications processor is the monitoring bus, a 16-bit bus connecting every major block in the chip. This can be a multiplexed address/data bus and can be clocked at 150 MHz. The communications processor drives the addresses on this bus and can either read or write in the devices connected to the bus. The main purpose of the monitoring bus is to aggregate the performance data from various parts of the OCU and form the MIBs for the network management layers. Similarly, performance functions in the O C U (error rates) may be dynamically updated by the host processor. Note that the host processor refers to the main CPU on the host server. The communications processor 70, however is a collection of state machines and need not necessarily imply any CPU functionality.

The bus interconnect controller (BIC) 72 is the central arbitrator and cross-connect for the other blocks within the OPX system to allow data transfer of traffic flow between ports. The BIC will allow non-blocking full-duplex connection to all blocks, except the LAMP and the BIC memory, which are only half-duplex. The BIC will also manage buffer memory for packets awaiting their destinations. Packet traffic across the BIC may be command and response packets used to determine status and availability of destination ports, or the traffic could be actual data packets. All connection arbitration is done using a round-robin format, helping to ensure fairness for each request, and all connection requests that are granted are guaranteed to give command/data delivery, so that there are no collisions or retries within this architecture. The LAMP port is a proprietary interface used to connect multiple OCUdevices or other devices that will interface with the OCU.

During a transmit operation, Ethernet or Fiber Channel ports will arbitrate with the BIC module for transfer of EFC data packets encapsulated in PPP frame, and dump the data into the EFC memory. While the packets are forwarded to the EFC memory, the BIC snoops the label stack within the EFC frame, and updates the command queue with the parameters (address, length, and label stack) for the new/pending packet to be transported once the data is in the memory. The packet engine will get the command queue parameters from the BIC and segregate them in a set of priority queues according to the associated service class (priority) information in the label stack. The packet engine will then issue a request for the BIC requesting access for the pending highest priority EFC data, which will be transmitted by the EFC memory controller using LAMP protocol. Concurrently, the label ID fields will be used to perform table look-up on the routing tables to switch payload to the destination node. If the destination of the packet is outside the OPX domain (trunk node), the label will be stripped off the packets and either segmented into ATM cells in the SAR (if the packet is destined to an ATM public network) or transported as is (if the packet is destined to another OPX network). If the packet is traversing within a OPX ring, the label will be preserved, and ATM SAR is bypassed. The segmented or raw encapsulated payload will be transported to one of the channels in the SONET-OUT micro engine.

Data communication channel (DCC) packets will be fetched from the server main memory through GIU ports and stored in a dedicated local buffer before being transported to the SONET-OUT micro engine. The transmission of DCC packets will be done prior to the actual payload.

During a receive operation, the SONET-IN micro engine will pass the dropped SONET payload onto the associated the de-framer blocks 71. The de-framer blocks will buffer the incoming payload in a local buffer before dumping it into the SONET memory through the SONET memory controller. In addition to buffering the payload, the de-framer were will also snoop the VPI/VCI (in an ATM trunk node) or label stack (in a ring node) and forward them to the packet engine along with other parameters (address and length) of the new payload. The packet engine will save the payload parameters in dedicated queues according to the service class (priority) information. Once the SONET payload is dumped into the memory, the de-framer will assert the package ready signal to the packet engine, and the packet engine will use the parameters from the priority queue to fetch the data from memory and process in either through the SAR (in ATM trunk node) or strip the PPP frame before forwarding it to the EFC port. While the package is being fetched from the SONET memory, the packet engine will concurrently do table look-up using the label ID on the routing table to switch packets to the destination node.

The SONET-IN micro engine receives the dropped SONET payload, strips transport and path overhead bytes, and forwards the SPE (Synchronous Payload Envelope) to the de-framer blocks connected to the individual drop channel. The main function of the de-framer blocks is to snoop the label stack off of the incoming SONET payload and forward the packets to off chip SONET memory. Every incoming SONET payload in an OPX ring will have embedded label stack with service class (priority) affirmation, and packets need to be processed in the packet engine based on the embedded priority. Once the label stack is snooped, it will be segregated by the packet engine in a set of transmit priority queues according to the associated service class.

There are four de-framer blocks in an OCU chip, one for each of the four-drop channels. Each de-framer block has sufficient buffer space to hold onto the SONET payload before dumping it into the SONET memory. Once the packet is dumped into the SONET memory through the SONET memory controller, the de-framer asserts a package_ready signal to the packet engine, this sets the packet engine to fetch the data from the memory to further process and forward the packet to the destination Port. In addition to the label stack information the de-framer also provides the address of the location in the SONET memory to fetch the payload and the length of the payload. The address and length parameters are held along with the label stack in the transmit priority queue.

The packet Engine interfaces with the SONET memory controller to fetch the SONET payload from the solid memory. The SONET memory is an off-chip 8 MB DRAM, which holds the SONET payload dropped from the de-framer blocks before being further processed by the packet engine.

The payload will be forwarded to the SONET-OUT micro engine from the packet engine to be added to the appropriate SONET output channel. DCC bytes will be added to the appropriate over head section and payload will be packed into the payload envelope in the SONET-OUT micro engine before it is passed on to the output channel.

The bus interconnect controller (BIC) 72 is a set of cross-connect modules which handle the data flow between EFC ports, EFC memory, the packet engine, the LAMP (to a secondary OPU chip) and the SONET-OUT micro engine. The packet engine interfaces with the BIC to fetch data from the EFC memory during transmit operation, and it sends payload from the SONET input section to the EFC ports or to the packet engine on the secondary OPU chip through the LAMP during the receive operation. The BIC 72 mainly serves as a central arbiter between modules, and facilitate smooth flow of traffic.

Outgoing EFC packets during transmit operation will be dumped into the off-chip EFC memory (8 MB SDRAM) by the EFC ports through the BIC. The packet engine interfaces with the EFC memory controller 67 through the BIC to fetch outgoing EFC packets and forward them to the SONET-OUT micro engine.

The routing directory (LDIR), also called the forwarding information base (FIB) is a table with label ID, next hop, and trunk node ID fields. The packet engine uses LDIR to obtain the destination port address (next hop and trunk and node ID) to route the traffic either to the SONET-OUT channel, EFC port, or secondary OPU device through the LAMP bus. Label ID from the incoming/outgoing packet is used to index through the LDIR to get the corresponding next hop, trunk node ID and channel ID information.

The packet Engine interfaces with the generic interface unit (GIU) 63 to transmit/receive packets to/from the trunk chip and OPU ring chips on an open OPX card.

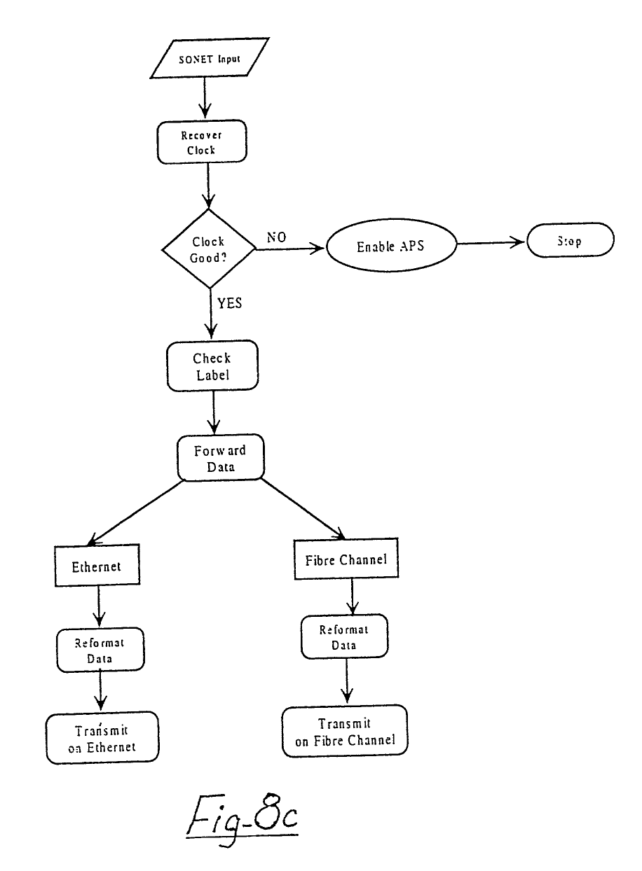

To label a packet, a short, fixed-length label is inserted between the Data Link header and the Data Link protocol-data units of the packet. More specifically, the Label is generated based on the Fibre Channel Domain ID and Destination OPX Node ID. The Domain ID is created from the Domain field of the D_ID from the Fibre Channel Frame header. The Destination OPX Node ID is generated by lookup of the Domain ID in the OPX Routing table. The Port ID, which is a 4-bit field, identifies the OPX port at the destination node. As illustrated in FIG. 8a, the OPX Label stack 80 is located at the fifth byte of a PPP packet 82 which can be either a Fibre Channel Packet or an IP Packet.

A “Forwarding Information Base (FIB)” Table 84 (FIG. 8b) is set up to bind the “Data Flow Label” with the “Next Hop” Node address. With this table, Layer 2 switching is performed at the hardware level.

The OPX labels are generated by the OPX layer 3 routing system. Whenever new Fibre Channel enters the OPX network, the ingress OPX node will go through the following steps for data forwarding:

1) Parse the Fibre Channel header

2) Extract the destination Domain address

3) Perform routing table lookup

4) Determine the next-hop address

5) Calculate header checksum

6) Generate Label (based on the Domain address and Forwarding Information Base, see section 3.4 for description)

7) Append Label to the packet

8) Apply appropriate outbound link layer encapsulation

9) Transmit the packet

When the Fibre Channel packet reaches the next hop, the OPX™ will inspect the packet label and forward the packet accordingly. As an OPX node receives a labeled packet, the incoming label is first extracted. Then the “incoming label” is used to look up the “next hop” address in the Label Forwarding Table. An “outgoing label” is then inserted into the packet before the packet is sent out to the “next hop”. No label will be inserted into the packet if the packet is to be sent to an unlabelled interface (e.g. to a non-OPX device).

The OPX Data Forwarding engine will distribute the label information among the OPX nodes by using conventional routing protocols such as RIP, OSPF, and BGP-4. The label information, which defines the binding between the labels and the node address, will be piggybacked onto the conventional routing protocols.

In addition to providing a high performance data forwarding function, the OLS mechanism can also be used to support applications such as Virtual Private Networks(VPN) and Traffic Management in future OPX releases (with Quality of Service support).

The Forwarding Information Base, which is generated by the OPX software, is used by the Data Forwarding engine to forward the Fibre Channel packets to the appropriate OPX node based on the label ID. The Forwarding Information Base contain three columns; they are:

Label_The label field contains the Label ID which is used as the key for the data forwarding engine to lookup the next hop node ID for packet forwarding.

Next Hop_Next Hop field indicate which OPX node the packet should be forwarded to. If the Next Hop value is zero, it means that the current node which is inspecting the packet is the destination node. Then the data forwarding engine will forward the packet to the port identified by the Node Info field.

Node Info_The Node Info field identifies the OPX port to which the packet should be forwarded. If the following condition exists, then the OPX will forward the packet to the “Trunk Port”: (1) The Domain ID in the Label indicates external domain, the Next Hop value is zero, and the Node Info value is 15.

Labels will be inserted into packets which are entering the OPX network from any one of the OPX interface ports; this includes Ethernet ports, Fibre Channel ports, and SONET Trunk interfaces. When a packet exits the OPX network, the OLS label will be removed from the packet.

FIG. 8c is a simplified flow chart illustrating the data transfer process in sending data from the WAN to either the SAN or the LAN environment. The SONET system recovers a 2.4 GHz clock from the serial data stream. This clock will be used to time the subsequent data streams. The SONET serial data is then converted to a parallel data stream and is stored in memory. When data has arrived, the Packet Engine starts to search the data (in fixed pre-specified locations) for a “label”. This label is LightSand Communications specific and contains information about the node identification, number of hops and so on.

Since each OPX node has a unique identifier, the Packet Engine is able to “sort” the data packets and forward them to the Ethernet, Fibre Channel or SONET ports on either OCU. Furthermore, any traffic designated for this Server can also be filtered in the Packet Engine and forwarded to the Server using the GAP Bus.

Since OCU has an address range that OPX software assigns at System Boot time, every function block in the OCU can be monitored by the Server using management information. Further, certain performance characteristics can be altered by the software using the same addressing scheme. This is conventionally done in the prior art using a “back plane”. However, the OPX architecture is unique in that it uses the System Bus to perform a back plane function. This direct involvement of the Server CPU makes the state of the Network visible to the Server and enables global management of the OPX enabled network. The tight integration between the Server and the communications system also enables applications to tailor the network according to the performance needs at the time.

Communications between OCUs on the same card is accomplished through the LAMP Bus. This bus can be extended to scale across OPUs to extend the use of a conventional back plane. This feature is extremely valuable when the OPX architecture is used in applications that need data rates greater than OC-48 (STS-48-2.4 Gbps)

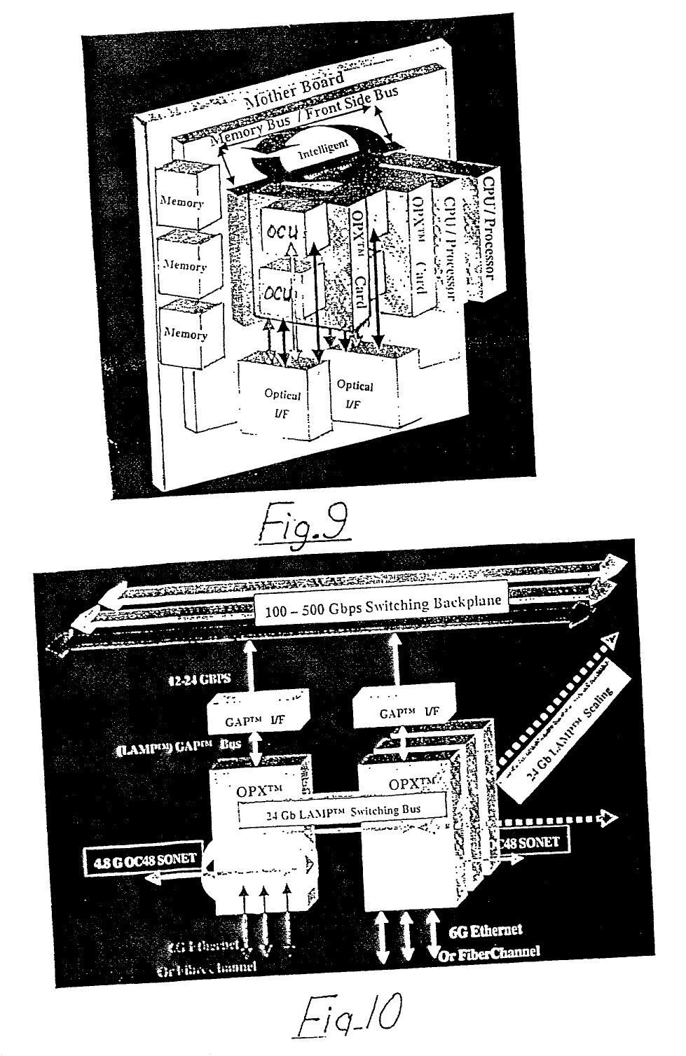

FIG. 9 illustrates in perspective a pair of OPX Cards as mounted to the Mother Board of a Server. As shown, the OPX Cards include dual OCUs, and the cards are inserted in CPU slots in the Server. This a novel approach towards integrating bandwidth and compute on the same platform. In the present state of the art the processing power of CPUs is increasing rapidly; but on the other hand, I/O bandwidth has saturated and will soon be unable to supply the high-speed CPUs with the data rates they need. By moving the I/O demand function into the compute function, the OPX system delivers high data rates directly into the CPUs.

The illustrated example is an Intel CPU (Xeon) based configuration. However, the OPX system card of the present invention is applicable to almost all types of host processors and system buses.

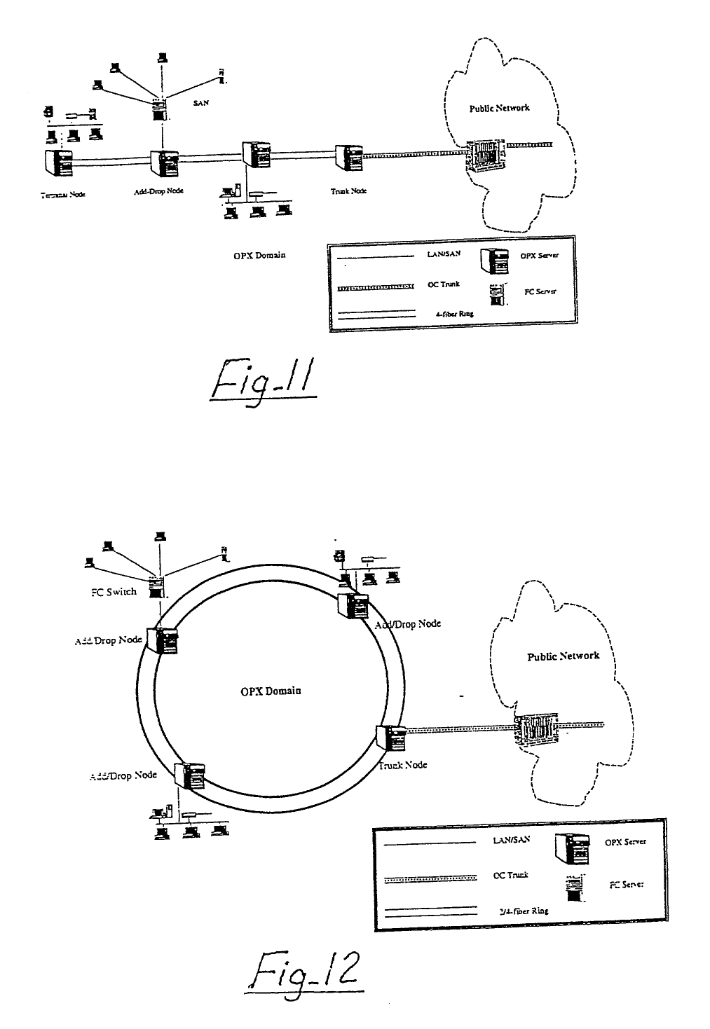

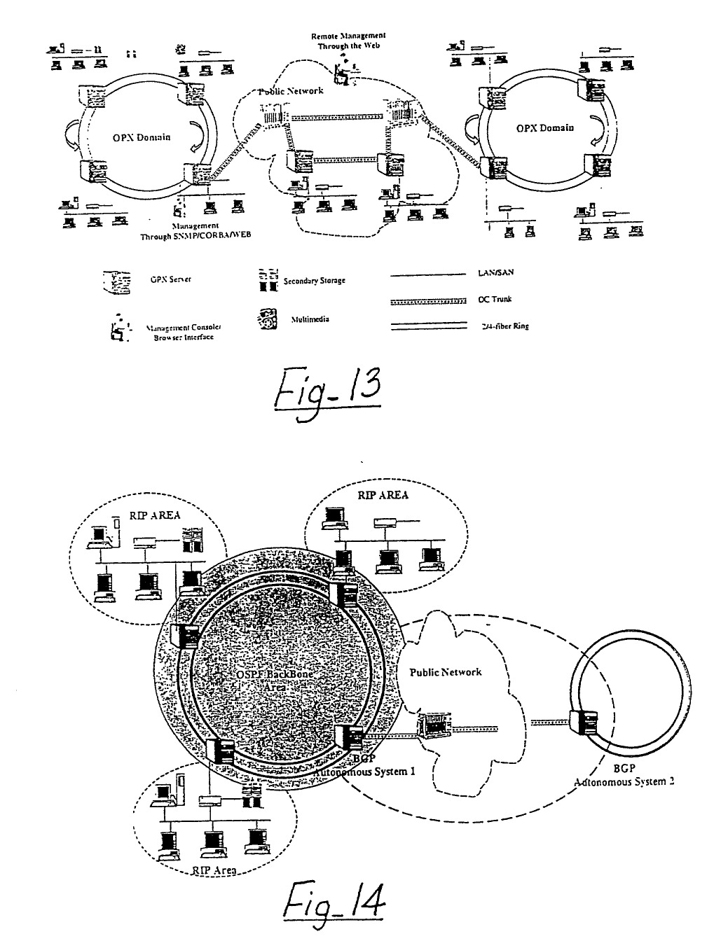

FIG. 10 depicts the scalability model of the OPX architecture. In the OPX network, the network nodes are responsible for transporting SONET payloads from source to destination based on the configuration. By adding multiple OPX Cards to the system, the OPX topology can be configured to support various network topologies including those shown in FIGS. 11, 12, 13 and 14. The OPX Networking Model supports at least three types of network nodes. They are:

Terminal Node_this type of node is needed for linear OPX systems. These nodes will perform functions similar to those performed by the Add/Drop node; the only difference is that no “Pass Through” function is allowed.

Add/Drop Node_the purpose of the Add/Drop node is to provide the Cross-Connect function for the SONET signals at the physical level (optical switching management). In addition, it will perform packet switching based on the signal type. Two OPX cards will be used to support the Add/Drop and SONET transport functions.

Trunk Node_the OPX node which is connected to the Service Provider is called the “Truck Node”. The initial trunk support is a single Bi-directional OC-48 optical connection to the public/private provider's WAN network. All traffic will be terminated at the Trunk node and forwarded to the destination based on the provisioned traffic.

The OPX system can be configured to provide high reliability to support Enterprise class applications. With redundant OPX cards and protection optical fibres, the OPX system can provide a self-healing function for any single point of failure. The self-healing function is transparent to users and no service interruption will be encountered for any single fibre cut or OPX card failure. With the self-healing feature, the OPX system solidifies the data transport for any Mission-critical Enterprise application.

The OPX system also provides remote management capability through an embedded Web-based management agent. Users can control and manage any node within the OPX network, as well as the whole OPX network, from anywhere at any time through the standard web interface (commercially available web browser such as Internet Explorer or Netscape Navigator). The OPX Management System (OMS) provides a highly secured access control mechanism so that only the user with proper credentials can access and manage the OPX network. With the remote management capability, it reduces operational costs, especially for remotely-located systems.

What is claimed is:

1. Transmission system including a synchronizer for forming a multiplex signal, a device for conveying the multiplex signal, and a desynchronizer which comprises at least:
a buffer store for buffering transport unit data contained in the signal;
a write address generator for controlling the writing of the data in the buffer store;
a control arrangement for forming a control signal for the write address generator from the signal;
a read address generator for controlling the reading of the data from the buffer store;
a difference circuit for forming difference values between the addresses of the write and read address generators,
a generating circuit for generating from a difference signal a read clock signal which is applied to the read address generator,
a correction circuit, and
a combiner circuit, wherein the control arrangement is provided for determining the offset of at least one transport unit in the signal and for applying the determined offset to the correction circuit which correction circuit is used for forming the phase difference between a lower-order transport unit and a higher-order transport unit, and in that the combiner circuit is provided for providing the difference signal to the generating circuit by combining a correction value resulting from the subtraction of the two phase differences, and a difference value from the difference circuit.
